(19) United States
(12) Patent Application Publication
(10) Pub. No.: US 2011/0267928 A1
(43) Pub. Date: Nov. 3, 2011

(54) Chronograph timepiece

(76) Inventor: Kazumi Sakumoto, (US)

(21) Appl. No.: 13/066,862

(22) Filed: Apr. 27, 2011

(30) Foreign Application Priority Data
Apr. 30, 2010 (JP) 2010-105968
Feb. 22, 2011 (JP) 2011-035999

(51) Int. Cl. G04F 8/00

(52) U.S. Cl. 368/112

(57) ABSTRACT

Chronograph hands are made not to start driving at an inappropriate position in a case where a sleep mode is cancelled in a chronograph timepiece in which driving of each of the hands is electrically performed by motors and reset-to-zero of the chronograph hands is performed by mechanical mechanisms. An operation mode setting portion forbids a chronograph measurement operation if only a start and stop button is operated after a sleep mode is cancelled by an amount of power generated by a solar cell exceeding a predetermined amount, and, if a reset button is operated after the sleep mode is cancelled, performs a control such that the chronograph measurement operation is started by a start operation using the start and stop button.

### BACKGROUND OF THE INVENTION

1. Field of the Invention

The present invention relates to a chronograph timepiece having a function for indicating time and a function for measuring time.

2. Background Art

In the related art, in a chronograph timepiece having a basic function of displaying time information, and further a chronograph measurement function for measuring time, there has been developed a chronograph timepiece in which driving of each of the hands is electronically performed by driving motors and the reset-to-zero of chronograph hands is performed by mechanical mechanisms such as heart cams (refer to Japanese Patent No. 4244643, JP-A-61-73085, JP-A-2006-78423, and JP-A-2005-3493).

In addition, there have been developed electronic timepieces having a power generation device such as a solar cell. Among the electronic timepieces, there has been developed an electronic timepiece in which the entire system of the electronic timepiece enters a low power consumption mode (sleep mode) according to a charging state of a secondary cell or a power generation state of the power generation device in a case where power output from the secondary cell is reduced.

For example, in a case where the function of the low power consumption mode is added to a chronograph timepiece as disclosed in Japanese Patent No. 4244643, there can be a configuration in which only power used to measure time information is maintained and the timepiece enters the sleep mode. At this time, there can be a configuration in which time hands for displaying time are reset to the hour position, and if the power generation state of the power generation device or the charging state of the secondary cell recovers sufficient power to drive the system, the sleep mode is cancelled, and the display hands which had been reset are moved to display current time.

However, in the chronograph timepiece which performs the reset using the mechanical mechanisms such as the heart cams as disclosed in Japanese Patent No. 4244643, in a case of entering the sleep mode, since the reset to the hour position cannot be performed automatically by electronic control, the chronograph hands for displaying measured time are stopped at a timing of entering the sleep mode.

In this state, in a case where a voltage from the secondary cell is charged up to a predetermined amount, the sleep mode is thus cancelled, and a chronograph measurement start switch is pushed down by a user, the measurement starts at a position where the chronograph hands are stopped in the sleep mode. Essentially, since the measurement is stopped at the point of time of entering the sleep mode, for example, even if the measurement is started from the stopped position of the hands, it corresponds to driving from an inappropriate position, and thus the measurement time has no meaning.

In addition, in a multi-function timepiece having a means for finishing the chronograph measurement when a measurement time becomes the maximal measurement time, since a start position of a display hand is not an hour position, a stop position at the maximal measurement time is different from the hour position, and thus there is a problem in that a user may not directly read the lapse time and thinks it has broken down.

### SUMMARY OF THE INVENTION

It is an aspect of the present application to enable chronograph hands not to start driving at an inappropriate position in a case where a sleep mode is cancelled in a chronograph timepiece in which driving of each of the hands is electrically performed by motors and reset-to-zero of the chronograph hands is performed by mechanical mechanisms.

According to an embodiment of the application, there is provided a chronograph timepiece including chronograph hands that display measured time when chronograph measurement is performed; a motor that rotatably drives the chronograph hands; operation means that performs start, stop, and reset operations of the chronograph measurement; control means that drives the motor by starting a chronograph measurement operation in response to the start operation using the operation means and stops driving of the motor by stopping the chronograph measurement operation in response to the stop operation; reset means that mechanically resets the chronograph hands to zero in response to the reset operation using the operation means so as to be maintained and electrically resets the chronograph measurement operation; a secondary cell as a power source; and mode changing means that changes operation modes of the control means such that a transition to a sleep mode occurs in which the chronograph measurement operation is forbidden when a voltage from the secondary cell is reduced to a predetermined voltage or less and the sleep mode is cancelled so as to start the chronograph measurement operation when the voltage from the secondary cell exceeds the predetermined voltage, wherein the mode changing means controls the control means in order not to start the chronograph measurement operation even when the start operation is performed using the operation means after the sleep mode is cancelled.

According to the application, it is possible to enable chronograph hands not to start driving at an inappropriate position in a case where a sleep mode is cancelled in a chronograph timepiece in which driving of each of the hands is electrically performed by motors and reset-to-zero of the chronograph hands is performed by mechanical mechanisms.

### BRIEF DESCRIPTION OF THE DRAWINGS

FIG. 1 is a block diagram of a chronograph timepiece according to an embodiment of the invention;

FIGS. 2A and 2B are plan views illustrating an outline of a mechanical configuration of a chronograph mechanism in the chronograph timepiece according to the embodiment of the invention;

FIG. 3 is a plan view illustrating an exterior of the chronograph timepiece according to the embodiment of the invention;

FIG. 4 is a flowchart according to the embodiment of the invention; and

FIG. 5 is a flowchart according to another embodiment of the invention.

### DETAILED DESCRIPTION OF THE INVENTION

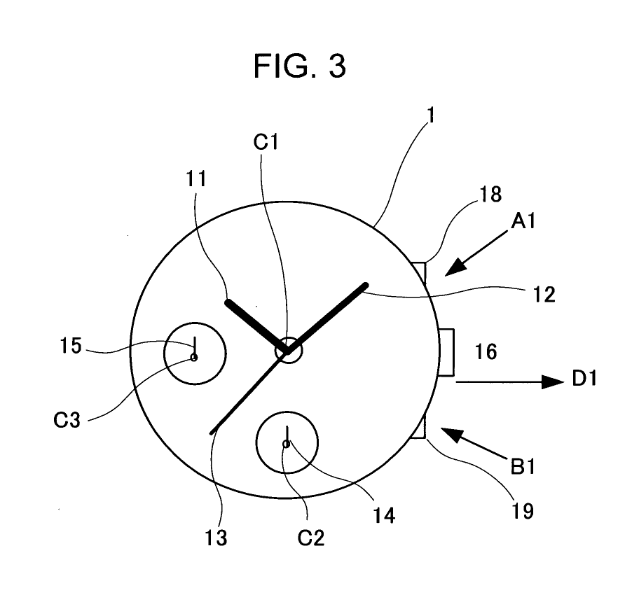

The chronograph timepiece 1 according to this embodiment, as shown in FIG. 3, has a wristwatch form, includes time hands (an hour hand 11, a minute hand 12, and a second hand 13 which rotate around the central axis line C1) displaying current time, and further includes chronograph hands (a chronograph second hand 14 rotating around the central axis line C2 and a chronograph minute hand 15 rotating around the central axis line C3).

For example, a winding stem 16 is operated in a state of being pulled in the direction D1 by one level, and thus the time hands 11 and 12 can rotate. The operation related to a typical time display in the chronograph timepiece 1 is the same as in a general electronic timepiece and is well known to a person skilled in the art, and thus descriptions of structures, functions, and operations related to the normal hand operation will be omitted.

In the chronograph timepiece 1, the chronograph hands 14 and 15 are controlled to be driven electrically by motors, and reset-to-zero thereof is controlled by a mechanical configuration.

In the chronograph timepiece 1, a start and stop button 18 is pushed in the direction A1, and thus the chronograph operation by the chronograph timepiece 1 is instructed to be started and stopped. More specifically, the start and stop of the chronograph operation indicate starting and stopping of the operation of the chronograph hands 14 and 15, and, as described later, in relation therewith, an operation of an electrical driving system and maintaining of electrical position information for the chronograph hands are performed. However, as necessary, the electrical position information for the chronograph hands may not be maintained.

In the chronograph timepiece 1, a reset button 19 is pressed in the direction B1, and thus a reset of the chronograph operation by the chronograph timepiece 1, that is, return (reset-to-zero) to an initial state is instructed. More specifically, the reset of the chronograph operation indicates a forced return (reset-to-zero) to an initial position (hour position) of the chronograph hands 14 and 15, setting of operations of the chronograph hands 14 and 15, and reset of the electrical position information for the chronograph hands 14 and 15. In addition, the start and stop button 18 and the reset button 19 constitute an operation means.

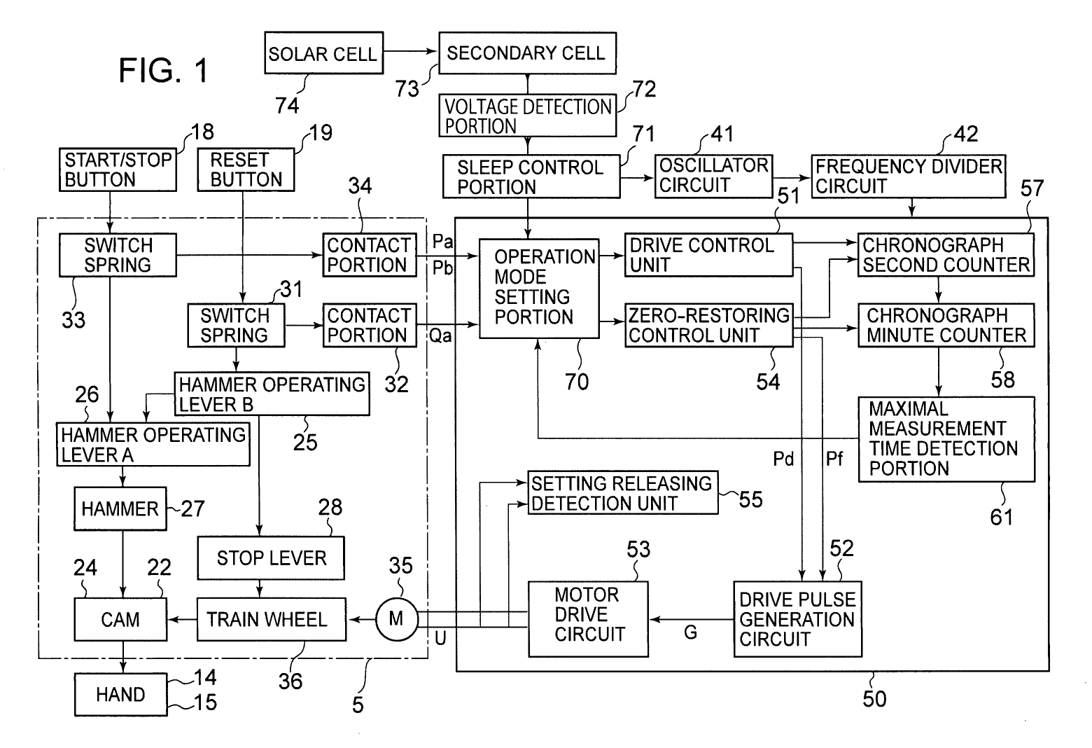

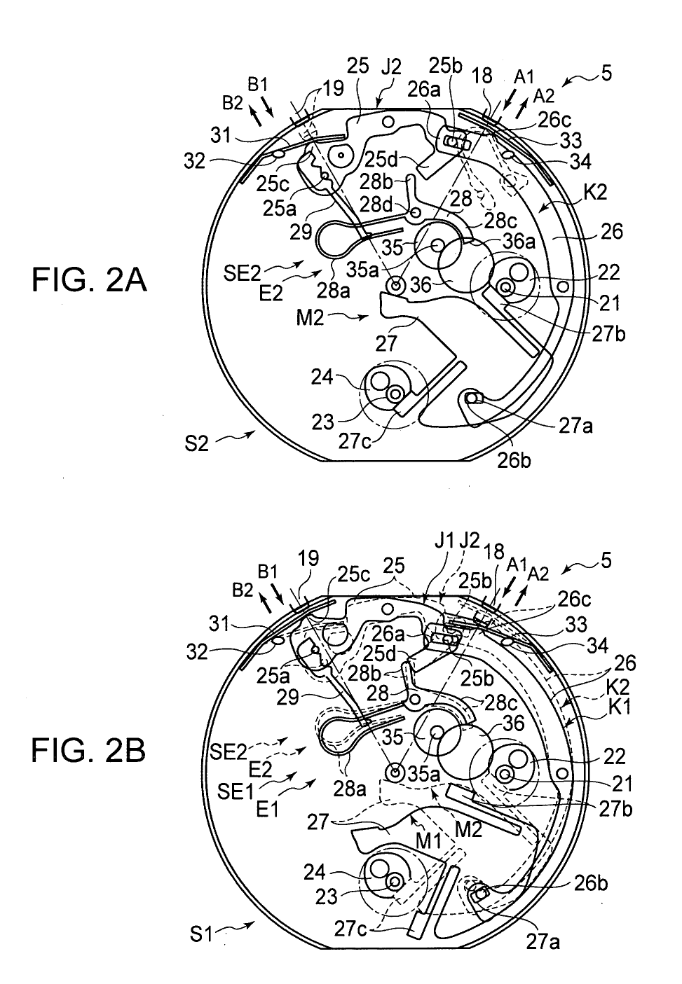

To begin with, a mechanical structure 5 and an operation related to the start, the hand operations, and the reset-to-zero in the chronograph timepiece 1 will be described based mainly on FIGS. 2A and 2B. In addition, the mechanical structure 5 related to the start, the hand operations, and the reset-to-zero in the chronograph timepiece 1 is also shown simply in the left part of the block diagram in FIG. 1.

The chronograph timepiece 1 includes a chronograph hand operation motor 35 independently from a normal hand operation (time hand operation) motor (not shown), and, the rotation driving of the chronograph hand operation motor 35 operates the chronograph hands 14 and 15 via a chronograph hand operation wheel train 36.

The normal hand operation motor or the chronograph hand operation motor 35 is a well-known stepping motor which is used for timepieces. The stepping motor includes a stator which has a rotor containing hole and a positioning portion which sets a stop position of a rotor, a rotor which is installed in the rotor containing hole, and a driving coil. By generating magnetic flux in the stator through signals (driving pulses) with different polarities being alternately supplied to the driving coil, the rotor is rotated and the rotor is stopped at a position corresponding to the positioning portion. Each time the rotor is driven by the driving pulses with different polarities, the rotor is continuously rotated by a predetermined angle (for example, 180 degrees), and in a case where the rotor is rotated by the initial driving pulse even if a plurality of driving pulses with the same phase is continuously applied, the rotor is not rotated by the driving pulses with the same phase after the second.

The chronograph timepiece 1 includes a chronograph second cam 22 which is installed in a chronograph second stem 21 where the chronograph second hand 14 is positioned, and a chronograph minute cam 24 which is installed in a chronograph minute stem 23 where the chronograph minute hand 15 is positioned.

The chronograph timepiece 1 includes a first hammer operating lever (hereinafter, also referred to as a “hammer operating lever B”) 25, a second hammer operating lever (hereinafter, also referred to as a “hammer operating lever A”) 26, a hammer 27, and a stopping lever 28.

The chronograph second cam 22, the chronograph minute cam 24, and the hammer 27 constitute a setting mechanism, and the second hammer operating lever 26 and the hammer 27 constitute a cancellation means. In addition, the chronograph second cam 22, the chronograph minute cam 24, the hammer 27, the first hammer operating lever 25, and the second hammer operating lever 26 constitute a mechanical reset means. Further, the first hammer operating lever 25, the second hammer operating lever 26, and the hammer 27 constitute a lever means.

The first hammer operating lever 25 can be rotated between the reference position J1 (the solid line in FIG. 2B) and the reset-to-zero position J2 (the dotted line in FIG. 2B and the solid line in FIG. 2A), is engaged with a spring shaped positioning member 29 having a groove with which a positioning pin 25a is engaged, and is positioned at the reference position J1 or the reset-to-zero position J2. The second hammer operating lever 26 is engaged with a pin 25b of the first hammer operating lever 25 in an elongated hole 26a. If the first hammer operating lever 25 sets the position thereof to the reset-to-zero position J2 through movement from the reference position J1, the second hammer operating lever 26 is moved from the reference position K1 (the solid line in FIG. 2B) to the reset-to-zero position K2 (the dotted line in FIG. 2B in the solid line in FIG. 2A).

On the other hand, if the second hammer operating lever 26 sets the position thereof to the reference position K1 through movement from the reset-to-zero position K2, the first hammer operating lever 25 sets the position thereof to the reference position J1 through movement from the reset-to-zero position J2.

The hammer 27 is engaged with a pin 26b of the second hammer operating lever 26 in an elongated hole 27a, and is positioned at the reference position M1 (the solid line in FIG. 2B) or the reset-to-zero position M2 (the dotted line in FIG. 2B and the solid line in FIG. 2A) according to the position setting of the second hammer operating lever 26 to the reference position K1 or the reset-to-zero position K2.

If the hammer 27 is set to the reset-to-zero position M2, the hammer 27 taps the chronograph second cam 22 with a second hammer portion 27b such that the chronograph second hand 14 is reset to the initial position, and taps the chronograph minute cam 24 with a minute hammer portion 27c such that the chronograph minute hand 15 is reset to the initial position.

The stopping lever 28 includes a spring portion 28a, an engagement arm portion 28b, and a locking arm portion 28c, and can be rotated around a pin 28d between a correction control position at the time of the reset-to-zero or a setting position E2 (the dotted line in FIG. 2B in the solid line in FIG. 2A) and a correction control stopping position or an unsetting position E1 (the solid line in FIG. 2B). The locking arm portion 28c of the stopping lever 28 is engaged with any one wheel 36a of the chronograph hand operation wheel train 36 which is connected to a rotor wheel 35a of the chronograph hand operation motor 35 in a state SE2 where the stopping lever 28 is present at the setting position E2, so as to set the rotation of the wheel train 36, and is separated from the wheel 36a of the wheel train 36 so as to allow the rotor wheel 35a of the motor 35 and the wheel train 36 to be rotated in a state SE1 where the stopping lever 28 is present at the unsetting position E1.

The stopping lever 28, which is applied with the biasing force toward the setting position E2 in the spring portion 28a, is engaged with the arm portion 25d of the first hammer operating lever 25 in the engagement arm portion 28b and is rotatably displaced from the setting position E2 at the time of the reset-to-zero to the unsetting portion E1, when the first hammer operating lever 25 is rotatably displaced from the reset-to-zero position J2 to the reference position J1. On the other hand, if the first hammer operating lever 25 is moved from the reference position J1 to the reset-to-zero position J2, the engagement between the arm portion 25d of the first hammer operating lever 25 and the engagement arm portion 28b is cancelled, and thus the stopping lever 28 returns to the setting position E2 from the unsetting portion E1 due to the spring force of the spring portion 28a.

If the start and stop button 18 is pressed in the direction A1 when the chronograph timepiece 1 lies in the reset-to-zero (reset) state S2 shown in FIG. 2A, the second hammer operating lever 26 is pushed in the direction A1 by the protrusion 26c so as to be displaced from the position K2 to the position K1, and the first hammer operating lever 25 is displaced from the position J2 to the position J1 such that the hammer 27 is displaced from the position M2 to the position M1. Thereby, the rotation setting (the reset-to-zero control) of the heart cams 22 and 24 and the chronograph hands 14 and 15 by the hammer portions 27b and 27c are cancelled. In addition, according to the rotation of the first hammer operating lever 25 from the position J2 to the position J1, the stopping lever 28 which is engaged with the arm portion 25d of the first hammer operating lever 25 by the arm portion 28b is rotated from the setting position E2 to the unsetting portion E1, and the locking arm portion 28c of the stopping lever 28 is separated from the chronograph hand operation wheel train 36 so as to cancel the rotation setting (stopping control) of the wheel train 36. Thereby, the mechanical control mechanism 5 returns to the state S1 and thus the chronograph hands 14 and 15 can be rotated.

On the other hand, if the reset button 19 is pressed in the direction B1 when the chronograph timepiece 1 lies in the start state or the operation state S1 shown in FIG. 2B, the first hammer operating lever 25 is pushed in the direction B1 by the protrusion 25c and thus the first hammer operating lever 25 is displaced from the position J1 to the position J2. If the first hammer operating lever 25 is displaced from the position J1 to the position J2, on the one hand, the second hammer operating lever 26 engaged with the lever 25 is moved from the position K1 to the position K2, the hammer 27 engaged with the lever 26 is moved from the position M1 to the position M2, and the second hammer 27b and the minute hammer 27c tap the second heart cam 22 and the minute heart cam 24 such that the chronograph second hand 14 and the chronograph minute hand 15 are reset to zero. On the other hand, the arm portion 25d is unlocked from the stopping lever 28 such that the stopping lever 28 is rotated from the position E1 to the position E2, and is engaged with the chronograph hand operation wheel train 36 by the arm portion 28c so as to set the wheel train 36.

Regarding the chronograph timepiece 1, an electrical aspect in a range associated with the mechanical structure 5 shown in FIGS. 2A and 2B is as follows.

If the start and stop button 18 is pressed in the direction A1 when the chronograph timepiece 1 lies in the reset state S2 shown in FIG. 2A, the start and stop button 18 enables the contact portion 34 to be closed by pushing the start and stop switch spring 33 which applies the biasing force in the direction A2 around the inner end thereof, and enables a start signal Pa (FIG. 1) to be output to an operation mode setting portion 70 via the contact portion 34.

In this case, an operation mode inside the chronograph timepiece 1 is designated as a chronograph measurement (nm) mode. In the run mode, a basic driving control portion 51 outputs a chronograph measurement timing signal (in this embodiment, 5 Hz) to a chronograph second counter 57. The chronograph second counter 57 counts ⅕ seconds (5 Hz) five times, converts the ⅕ seconds into one second, and counts the accumulation for each second (chronograph second). The chronograph second counter 57 outputs a carry signal to a chronograph minute counter 58 at a point of time when the chronograph seconds reach sixty seconds, and the chronograph minute counter 58 counts the accumulation for each minute (chronograph minute). A maximal measurement time detection portion 61 detects whether or not the chronograph minute counter 58 reaches the maximal measurement time set in advance. The chronograph second and minute counters 57 and 58 perform the counting, and a driving pulse generation circuit 52 outputs driving pulse signals G every ⅕ seconds (5 Hz) and enables the motor 35 to be rotated using driving pulse signals U via a motor driving circuit 53.

In addition, if the start and stop button 18 is pressed in the direction A1 when the chronograph timepiece 1 lies in the start state S1 shown in FIG. 2B, the start and stop button 18 enables a stop signal Pb (FIG. 1) to be output to the operation mode setting portion 70 via the contact portion 34 by pushing the start and stop switch spring 33 such that the contact portion 34 is closed. The internal operation mode in this case is designated as a first chronograph measurement stop mode (stop mode). The run mode and the stop mode can be alternately switched in a cyclical manner each time the start and stop button 18 is pressed in the direction A1.

On the other hand, if the reset button 19 is pressed in the direction B1 when the chronograph timepiece 1 lies in the start state (or the stop state) S1 shown in FIG. 2B, the reset button 19 enables a contact portion 32 to be closed by pushing a reset switch spring 31 which applies the biasing force in the direction B2 around the inner end thereof, and enables a reset signal Qa (FIG. 1) to be output to the operation mode setting portion 70 via the contact portion 32. The inner operation mode in this case is designated as a reset mode. The reset mode can be changed from either of the run mode and the stop mode.

A voltage detection portion 72 detects an amount of power generated (currents generated by a solar cell 74) by the solar cell (solar power generation device) 74 which is a power generation means for charging a secondary cell 73 or a voltage of the secondary cell 73, and, in a case where a voltage from the secondary cell 73 is equal to or more than a predetermined voltage, determines the case as being in an overcharging state, and disconnects the solar cell 74 therefrom such that the voltage from the secondary cell 73 is not increased any more. In addition, in a case where the voltage from the secondary cell 73 is smaller than the predetermined voltage, the voltage detection portion 72 outputs a sleep signal to a sleep control portion 71. On the other hand, the voltage detection portion 72 detects the amount of power generation from the solar cell 74 by detecting a voltage corresponding to a current generated by the solar cell 74.

The sleep control portion 71 receives the sleep signal, and, to begin with, designates an output from the operation mode setting portion 70 as a sleep (stop 2) mode. In this case, if the chronograph measurement is performed, the driving signal U is also stopped. Next, an operation of an oscillation circuit 41 is stopped such that operations of the electronic circuits after a clock division circuit 42 are all stopped. In this state, although a predetermined voltage is applied, since there is no clock signal from the oscillation circuit 41, a driving control integrated circuit 50 is not operated.

Next, if the solar cell 74 receives light and generates power, the voltage detection portion 72 detects the power generation state. If detecting that the voltage from the secondary cell 73 is equal to or more than a predetermined voltage, or an amount of power generated by the solar cell 74 is equal to or more than a predetermined amount, the voltage detection portion 72 stops the output of the sleep signal which is being output. Since the output of the sleep signal is stopped, the oscillation circuit 41 is operated to supply clocks, and thus the driving control integrated circuit 50 starts to be operated.

If the start and stop button 18 is pressed in the direction A1 in either state shown in FIGS. 2A and 2B, the start and stop button 18 enables the contact portion 34 to be closed by pushing the start and stop switch spring 33 which applies the biasing force in the direction A2 around the inner end thereof, and enables the start signal Pa or the stop signal Pb to be output to the operation mode setting portion 70 via the contact portion 34. However, the operation mode setting portion 70 does not receive the start signal Pa or the stop signal Pb but maintains the current stop 2 mode since the current mode is the stop 2 mode. For this reason, there are no outputs from the driving pulse generation circuit 52 and the motor driving circuit 53, and thus the chronograph hand operation motor 35 is maintained to be stopped.

Next, if the reset button 19 is pressed in the direction B1, the reset button 19 enables the contact portion 32 to be closed by pushing the reset switch spring 31 which applies the biasing force in the direction B2 around the inner end thereof, and enables the reset signal to be output to the operation mode setting portion 70 via the contact portion 32. In this case, the operation mode setting portion 70 designates an operation mode as the reset mode regardless of a current inner operation. At this time, the mechanical mechanism enters the reset state S2 shown in FIG. 2A, the circuit enters the reset state, the mechanism and the circuit enter the initial state, and, thereafter, the chronograph measurement can be started by operating the start and stop button 18.

Among the above-described operations, more specific description will be made below mainly based on the starting and progressing of the start operation when the start and stop button 18 is pressed in the direction A1 in the reset-to-zero state S2 in FIG. 2A.

If the start and stop button 18 is pressed in the direction A1, on the one hand, the electrical driving start signal Pa is output via the switch contact point 34, thereby rotating the motor 35, and, on the other hand, the mechanical reset-to-zero control state is cancelled by the rotation of the hammer 27 due to the rotation driving of the second hammer operating lever 26, and the wheel train 36 is unlocked (stop control state) by the rotation of the stopping lever 28 due to the rotation of the second hammer operating lever 26 and the first hammer operating lever 25, thereby allowing a mechanical hand operation (the mechanical setting is cancelled).

Here, in order for the chronograph timepiece 1 to be appropriately operated and for the time measurement to be accurately performed, the rotation driving of the motor 35 is required to be performed after the mechanical setting is cancelled. In this chronograph timepiece 1, the electrical driving can be reliably performed after the mechanical setting is cancelled while the complexity of the structure and increase in costs accompanied thereby are prevented. Hereinafter, this will be described in detail.

Next, an outline of an electrical driving mechanism 6 of the chronograph timepiece 1 will be described mainly based on the block diagram in FIG. 1 with reference to the mechanical structure 5 in FIGS. 2A and 2B.

The rotation of the chronograph hand operation motor 35 of the chronograph timepiece 1 is controlled by the driving control integrated circuit 50 of the chronograph hand operation motor 35 which is controlled to be driven based on clock pulses which are applied via the oscillation circuit 41 and the clock division circuit 42.

The secondary cell 73 is a power source of the chronograph timepiece 1. The secondary cell 73 may be charged by a power generation device such as the solar cell 74. The voltage detection portion 72 detects a voltage from the secondary cell 73, and outputs the sleep signal to the sleep control portion 71 if the voltage from the secondary cell 73 is equal to or less than a predetermined voltage.

If receiving the sleep signal indicating that the voltage from the secondary cell 73 is equal to or less than the predetermined voltage, the sleep control portion 71 controls the oscillation circuit 41 such that the oscillation operation of the oscillation circuit 41 is stopped and outputs a sleep permission signal to the operation mode setting portion 70 such that the operation mode setting portion 70 allows the chronograph timepiece 1 to enter the sleep mode. If receiving a sleep cancellation signal indicating that the voltage from the secondary cell 73 is not equal to or less than the predetermined voltage, the sleep control portion 71, which lies in the sleep mode, controls the oscillation circuit 41 such that the oscillation circuit 41 starts the oscillation operation and outputs a sleep mode cancellation signal to the operation mode setting portion 70 such that the operation mode setting portion 70 allows the chronograph timepiece 1 to enter a normal operation mode (a mode for performing a time measurement operation) from the sleep mode.

The motor driving control integrated circuit 50 includes the basic driving control portion 51, the driving pulse generation circuit 52, the motor driving circuit 53, a reset-to-zero control portion 54, and a rotation detection circuit 55. Here, a driving means of a chronograph hand operation motor 35 is constituted by the motor driving circuit 53. The basic driving control portion 51, the driving pulse generation circuit 52, the motor driving circuit 53, and the rotation detection circuit 55 constitute a control means of the chronograph hand operation motor 35. The reset-to-zero control portion 54 constitutes an electrical reset means which performs an electrical reset, and constitutes a reset means along with the mechanical reset means. The voltage detection portion 72, the sleep control portion 71, and the operation mode setting portion 70 constitute a mode changing means.

In addition, the motor driving control integrated circuit 50 further includes the chronograph second counter 57 which counts chronograph seconds and maintains the chronograph second information, the chronograph minute counter 58 which counts chronograph minutes and maintains the chronograph minute information, a maximal measurement time detection portion 61 which detects that the chronograph minute counter 58 measures a predetermined maximal time and outputs a maximal time measurement signal to the operation mode setting portion 70, and the operation mode setting portion 70 which sets an operation mode. A chronograph hour counter which counts chronograph hours and maintains the chronograph hour information may be further provided. The chronograph second counter 57 and the chronograph minute counter 58 constitute a chronograph counter means.

The operation mode setting portion 70 receives the start signal or the operation signal Pa which is sent via the contact portion 34 in a case where the start and stop button 18 is pressed when the chronograph timepiece 1 lies in the reset-to-zero (reset) state S2, and outputs the signal to the basic driving control portion 51.

The operation mode setting portion 70 receives the stop signal Pb which is sent via the contact portion 34 in a case where the start and stop button 18 is pressed when the chronograph timepiece 1 lies in the start state S1, and outputs the signal to the basic driving control portion 51.

The operation mode setting portion 70 receives the reset signal Qa in a case where the switch spring 31 is pushed down due to the pressing of the reset button 19 such that the contact portion 32 is closed, and outputs the signal to the reset-to-zero control portion 54.

The operation mode setting portion 70 outputs the stop signal Pb to the reset-to-zero control portion 54 in response to the maximal time measurement signal from the maximal measurement time detection portion 61.

The basic driving control portion 51 receives the start signal or the operation signal Pa which is sent via the contact portion 34 in a case where the start and stop button 18 is pressed when the chronograph timepiece 1 lies in the reset-to-zero (reset) state S2, from the operation mode setting portion 70.

If receiving the start signal or the operation signal Pa, the basic driving control portion 51 generates a driving control signal Pd with a short interval for prevention of chattering. Hereinafter, unless particularly limited, a point of time when the start signal or the operation signal Pa is received and a point of time when the driving control signal Pd is transmitted are substantially the same as each other. The driving control signal Pd is a signal which is maintained to be in a high level during a period when the chronograph operation is performed.

If receiving the stop signal Pb which is sent via the contact portion 34 in a case where the start and stop button 18 is pressed when the chronograph timepiece 1 lies in the start state S1, from the operation mode setting portion 70 (or the transmission of the start signal or the operation signal Pa from the contact portion 34 is stopped), the basic driving control portion 51 stops transmitting the driving control signal Pd.

The driving control signal Pd from the basic driving control portion 51 is also sent to the chronograph second counter 57. While the driving control signal Pd is maintained to be in a high level, the chronograph second counter 57 receives clock pulses sent from the clock division circuit 42, counts chronograph seconds, and generates a chronograph timing pulse Ph for each cycle T from a point of time as a start point corresponding to the point of time when a time measurement is started as a chronograph, based on the driving control signal Pd. The cycle (chronograph hand driving cycle) T of the pulse Ph corresponds to the time measurement accuracy of the chronograph timepiece 1.

If receiving the driving control signal Pd, the driving pulse generation circuit 52 sends main driving pulses G for typical chronograph hand driving to the motor driving circuit 53. The motor driving circuit 53 sends motor driving pulses U corresponding to the main driving pulses G to the chronograph hand operation motor 35 such that the motor 35 is rotatably driven. Thereafter, the motor 35 is alternately rotated by a predetermined angle by being driven due to general main driving pulses U (P1-1 and P1-2) with different polarities.

On the other hand, if the basic driving control portion 51 receives the stop signal Pb, the basic driving control portion 51 stops transmitting the driving control signal Pd (as necessary, a driving stop signal Pf may be sent), the transmission of the driving pulses G from the driving pulse generation circuit 52 is stopped, and the transmission of the motor driving pulses U from the motor driving circuit 53 is stopped. In addition, the rotation driving of the chronograph hand operation motor 35 is stopped, the rotation of the rotor of the motor 35 or the output axis is stopped, and the operation of the chronograph hands 14 and 15 is stopped via the chronograph hand operation wheel train 36.

In a case where the switch spring 31 is pushed down due to the pressing of the reset button 19 such that the contact portion 32 is closed, the operation mode setting portion 70 sends the reset signal Qa to the reset-to-zero control portion 54. If receiving the reset signal Qa from the contact portion 32, the reset-to-zero control portion 54 sends the driving stop signal Pf to the driving pulse generation circuit 52. As a result, the driving pulse generation circuit 52 stops generating the driving pulses G and stops the motor driving circuit 53 transmitting the motor driving pulses U. Therefore, the rotation driving of the chronograph hand operation motor 35 is stopped and thus the operation of the chronograph hands 14 and 15 is stopped.

In addition, if receiving the reset signal Qa, the reset-to-zero control portion 54 resets the contents of the chronograph second counter 57 and the chronograph minute counter 58 to zero. The reset-to-zero control portion 54 controls the chronograph to be reset (stops the hand operation and resets the counters) in response to the reset signal Qa based on the reset operation of the reset button 19.

In addition, when the motor 35 has already been driven at the time of the operation of the reset button, the basic driving control portion 51 determines non-rotation due to the mechanical setting based on a result from the rotation detection circuit 55 if the rotation detection circuit 55 detects the non-rotation, and does not reverse a polarity of a driving pulse which the motor driving circuit 53 is scheduled to use the next time. Thereby, if the non-rotation due to the setting at the time of the reset-to-zero is detected, the driving is started by the driving pulse U with the same phase as the previous pulse when the chronograph measurement operation is restarted.

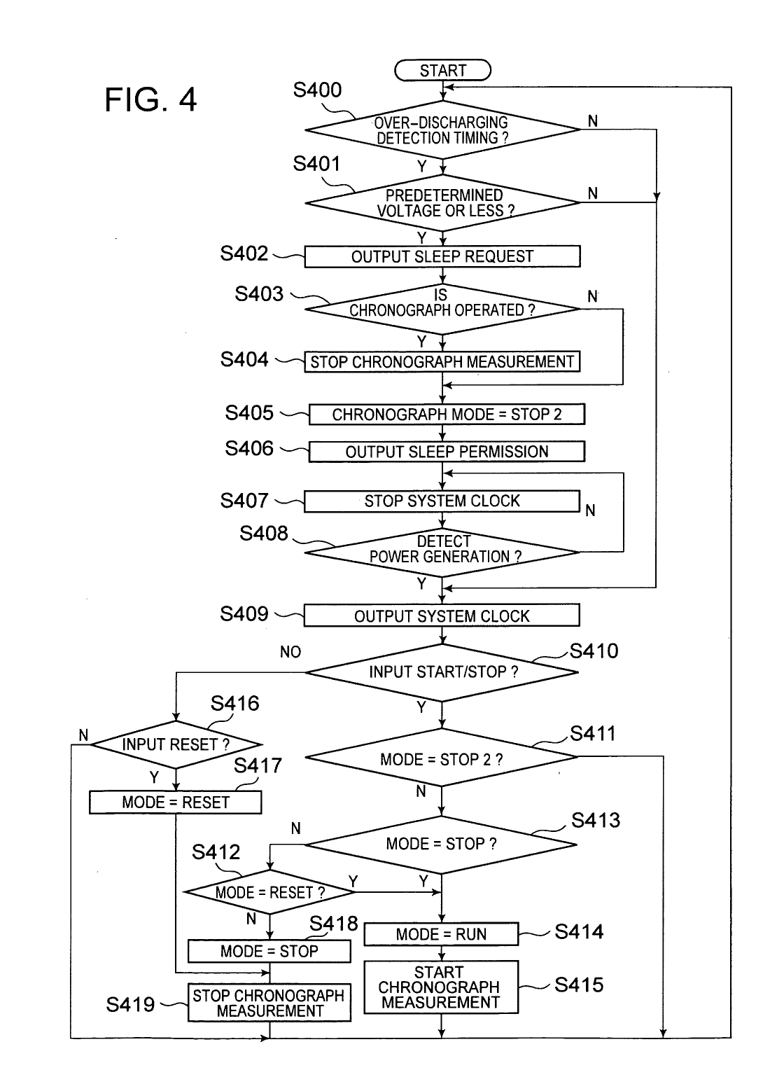

FIG. 4 is a flowchart regarding the chronograph timepiece according to the embodiment of the invention.

Hereinafter, with reference to FIGS. 1 to 4, an operation of the chronograph timepiece 1 according to the embodiment of the invention will be described in detail.

In FIG. 4, if the voltage detection portion 72 determines that an over-discharging detection timing comes for each predetermined time (step S400), it determines whether or not a voltage from the secondary cell 73 is equal to or less than a predetermined voltage (for example, a time measurement enabling voltage which is a voltage enabling at least a time measurement operation) (step S401). If it is determined that the voltage from the secondary cell 73 is reduced to the predetermined value or less, the voltage detection portion 72 outputs the sleep signal to the sleep control portion 71 so as to make a request for transition to the sleep mode (step S402).

The sleep control portion 71 receives the sleep signal, controls the operation mode setting portion 70 such that the chronograph measurement operation is stopped (step S404) during the chronograph measurement operation (step S403), and then performs transition to the second chronograph measurement stop mode (stop 2 mode) (step S405). If the chronograph measurement operation is not performed, transition to the stop 2 mode is instantly performed (step S405). In the stop 2 mode, if the chronograph measurement is performed, the chronograph measurement operation is stopped and the driving signal U is stopped, thereby stopping the driving of the motor 35.

Next, the sleep control portion 71 outputs the sleep permission signal to the operation mode setting portion 70 (step S406) such that the operation of the oscillation circuit 41 is stopped, thereby stopping system clocks (step S407). Thereby, operations of the electronic circuits after the clock division circuit 42 are all stopped, which leads to the sleep mode. In this state, since a predetermined power source voltage is applied to each electronic circuit, the voltage detection operation or the like of the voltage detection portion 72 is performed, but there is no clock signal from the oscillation circuit 41, and thus the driving control integrated circuit 50 lies in a non-operation state.

Next, if detecting that the solar cell 74 generates power equal to or more than a predetermined amount (step S408), the voltage detection portion 72 makes the sleep control portion 71 start the operation of the oscillation circuit 41 so as to output system clocks (step S409). Thereby, the sleep mode is cancelled. If the sleep mode is cancelled, a time measurement portion (not shown) which measures current time starts a time measurement operation, and measures current time by counting clock pulses sent from the clock division circuit 42. The time measurement portion displays the measured time using the time hands (the hour hand 11, the minute hand 12, and the second hand 13).

Here, instead of the voltage detection portion 72 detecting that the solar cell 74 generates power equal to or more than a predetermined amount, the voltage detection portion 72 may detect that a voltage from the secondary cell 73 exceeds a predetermined voltage, thereby making the sleep control portion 71 start the operation of the oscillation circuit 41 so as to output system clocks (cancellation of the sleep mode).

Next, the operation mode setting portion 70 determines whether or not the start and stop button 18 is operated (step S410). If it is determined that the start and stop button 18 is operated in the process step S410, in a case where the operation mode is not the stop mode but the stop 2 mode (step S411), the operation mode setting portion 70 does not start the chronograph measurement in the state where the operation mode is the stop 2 mode, and the flow returns to the process step S400. In a case where the operation mode is the stop mode or the reset mode (steps S413 and S412), the operation mode is changed to the run mode (step S414), and the chronograph measurement is started (step S415).

If it is determined that the operation mode is not the stop mode but the reset mode in the process steps S413 and S412, the operation mode setting portion 70 sets the operation mode to the stop mode (step S418) and stops the chronograph measurement (step S419).

If it is determined that the operation mode is the stop 2 mode in the process step S411, the operation mode setting portion 70 does not perform the chronograph measurement operation in the state where the internal operation mode is the stop 2 mode, and the flow returns to the process step S400. Thereby, even if the sleep mode is cancelled, the chronograph measurement is forbidden to be performed even when the start and stop button 18 is operated.

If it is determined in the process step S410 that the start and stop button 18 is not operated and the reset button 19 is operated (step S416), the operation mode setting portion 70 sets the operation mode to the reset mode (step S417), and the flow goes to the process step S419. Thereby, when the sleep mode is cancelled and the reset button 19 is operated, the chronograph measurement can be started by operating the start and stop button 18 thereafter. Therefore, in a case where the chronograph measurement is started after the sleep mode is cancelled, the chronograph hands 14 and 15 are driven from the hour position, and thus it is possible to prevent the chronograph hands 14 and 15 from being driven from an inappropriate position.

If the operation mode setting portion 70 determines that the reset button 19 is not operated in the process step S416, the flow instantly goes to the process step S419.

If the voltage detection portion 72 does not detect that the solar cell 74 generates power equal to or more than a predetermined amount in the process step S408, the flow 72 returns to the process step S407.

In addition, if the voltage detection portion 72 does not determine that the over-discharging detection timing comes in the process step S400 and the voltage detection portion 72 determines that the voltage from the secondary cell 73 is not reduced to the predetermined voltage or less in the process step S401, the flow goes to the process step S409.

As described above, in the chronograph timepiece according to this embodiment, the operation mode setting portion 70 forbids the chronograph measurement operation if only the start and stop button 18 is operated after the sleep mode is cancelled by an amount of power generated by the solar cell 74 exceeding a predetermined amount, and, if the reset button 19 is operated after the sleep mode is cancelled, performs a control such that the chronograph measurement operation is started by the start operation using the start and stop button 18.

Therefore, in the chronograph timepiece in which the driving of each of the hands is electrically performed using the motors, and the reset-to-zero of the chronograph hands is performed by the mechanical mechanism, if the sleep mode is cancelled, the chronograph measurement operation is performed after the reset-to-zero. Thus, it is possible for the chronograph hands not to start driving at an inappropriate position.

In addition, in this embodiment, although a state where the sleep control portion 71 receives the sleep request from the voltage detection portion 72 and stops the chronograph measurement (stop 2 mode) (the process step S405 in FIG. 4) has been described as the sleep mode, the sleep mode may include a state (the process step S407) where the system clocks are stopped (the oscillation stop of the oscillation circuit 41).

In addition, when the reset button 19 is operated, the chronograph measurement may not only enter the reset mode but the counters (the chronograph second counter 57, the chronograph minute counter 58, and the time measurement counter (not shown)) of the entire system of the chronograph timepiece may also be reset.

In addition, a state immediately after the sleep mode is cancelled is unstable, thus an operation is not guaranteed, and thereby the system reset may be performed using the reset button 19.

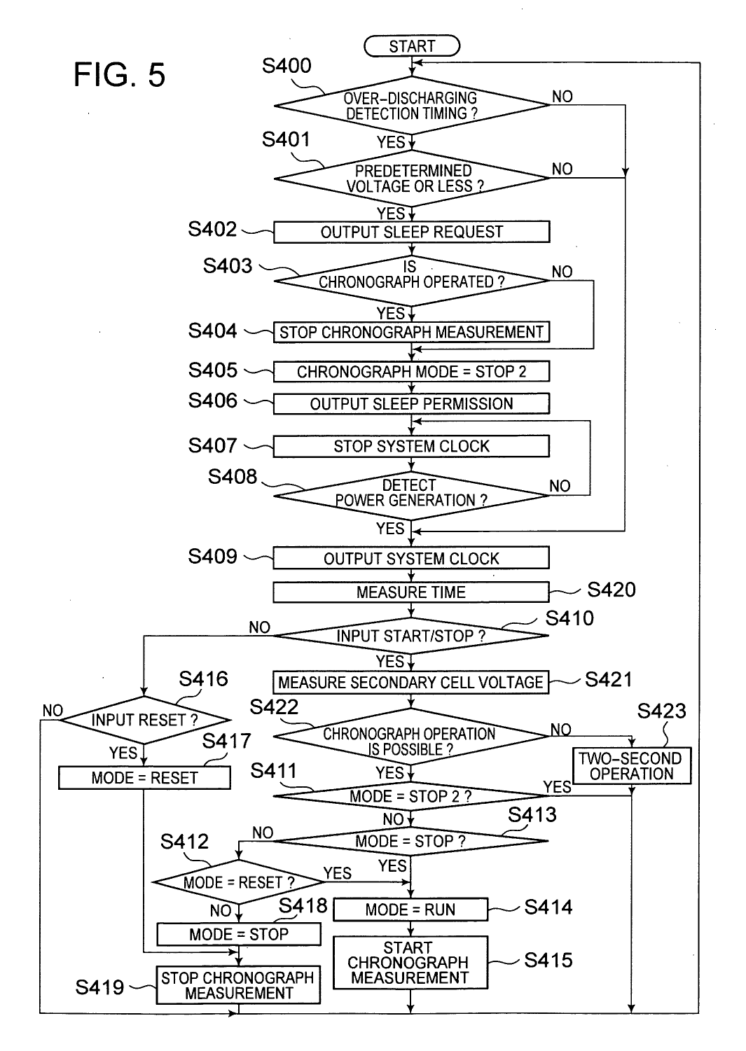

FIG. 5 is a flowchart in the chronograph timepiece according to another embodiment of the invention, and the same reference numerals are given to the parts which perform the same process as in FIG. 4. The block diagram, the chronograph mechanism, and the exterior of the chronograph timepiece according to another embodiment are the same as in FIGS. 1 to 3.

In the above-described embodiment, although the chronograph measurement operation is performed if the start operation is performed after the sleep mode is cancelled and the reset operation is performed, in another embodiment, the chronograph measurement operation is not performed in a case where a voltage from the secondary cell is not equal to or more than a predetermined voltage even if the start operation is performed after the sleep mode is cancelled and the reset operation is performed.

The reason is that the power required to drive the chronograph hand operation motor 35 is generally larger than the power required to drive a time hand driving motor (not shown). For this reason, if the chronograph measurement action is started even when the time measurement operation is possible after the sleep mode is cancelled, there is a problem in that a voltage from the secondary cell is rapidly reduced and thus transition to the sleep mode occurs again, and, therefore, another embodiment prevents this problem from occurring.

Hereinafter, with reference to FIGS. 1 to 3, and 5, an operation of another embodiment will be described based mainly on parts different from the above-described embodiment but also including parts common to the above-described embodiment.

If detecting that the solar cell 74 generates power equal to or more than a predetermined amount (step S408), the voltage detection portion 72 makes the sleep control portion 71 start the operation of the oscillation circuit 41 so as to output system clocks (step S409). Thereby, the sleep mode is cancelled. If the sleep mode is cancelled, the time measurement portion (not shown) which measures current time starts a time measurement operation, and measures current time by counting clock pulses sent from the clock division circuit (step S420). The time measurement portion displays the measured time using the time hands (the hour hand 11, the minute hand 12, and the second hand 13 in FIG. 3).

Here, instead of the voltage detection portion 72 detecting that the solar cell 74 generates power equal to or more than a predetermined amount, the voltage detection portion 72 may detect that a voltage from the secondary cell 73 exceeds a predetermined voltage (for example, a time measurement operation enabling a voltage which is a voltage enabling at least a time measurement operation), thereby cancelling the sleep mode so as to make the sleep control portion 71 start the operation of the oscillation circuit 41 and to output system clocks.

Next, the operation mode setting portion 70 determines whether or not the start and stop button 18 is operated (step S410). If the operation mode setting portion 70 determines that the start and stop button 18 is operated in the process step S410, the voltage detection portion 72 measures a voltage from the secondary cell 73 (step S421).

If the voltage from the secondary cell 73 is equal to or less than a voltage (a chronograph measurement enabling a voltage which is a voltage enabling a chronograph measurement operation) higher than the predetermined voltage by a constant voltage, the voltage detection portion 72 determines that the chronograph measurement operation is not possible (step S422). If it is determined in the process step S422 that the voltage from the secondary cell 73 is equal to or less than the chronograph measurement enabling voltage and that the chronograph measurement operation is not possible, the voltage detection portion 72 does not make the chronograph measurement operation enter the run mode (that is, it does not control the control means so as to start the chronograph measurement operation) even if the start operation is performed using the start and stop button 18 after the sleep mode is cancelled and the reset operation is performed using the reset button 19. In this case, the voltage detection portion 72 sends a predetermined notification (in another embodiment, a two-second operation) indicating that a voltage from the secondary cell 73 is not a voltage enabling the chronograph measurement operation, to the time measurement portion (step S423).

Typically, the second hand is operated by one step (corresponding to one second) for each second, but, in the two-second operation, the secondhand is collectively operated by two steps (corresponding to two seconds) every two seconds. A user can grasp that a voltage from the secondary cell 73 is not a chronograph measurement operation enabling voltage based on the operating state of the second hand.

If it is determined that the voltage from the secondary cell 73 exceeds the chronograph measurement enabling voltage in the process step S422, the voltage detection portion 72 determines that the chronograph measurement operation is possible, and, in the same manner as the above-described embodiment, performs processes after the process step S411.

As described above, the chronograph timepiece according to another embodiment has the same configuration as in the above-described embodiment, and, particularly, in a case where a voltage from the secondary cell 73 is equal to or less than the chronograph measurement enabling voltage higher than the predetermined voltage by a constant voltage, even when the start operation is performed using the start and stop button 18 after the sleep mode is cancelled and the reset operation is performed using the reset button 19, the mode changing means does not control the control means so as to start the chronograph measurement operation.

Therefore, as well as achieving the same effect as in the above-described embodiment, it is possible to prevent the occurrence of the problem that a voltage from the secondary cell is rapidly reduced and thus transition to the sleep mode occurs again in a case where the chronograph measurement operated is started after the sleep mode is cancelled and the time measurement operation is possible.

In addition, since a notification indicating that a voltage from the secondary cell 73 is not a voltage enabling the chronograph measurement operation is performed, it can be easily grasped that the voltage from the secondary cell 73 is reduced to the chronograph measurement enabling voltage or less.

The invention is applicable to various kinds of chronograph timepieces in which driving of time hands and chronograph hands is electrically performed by motors, the chronograph hands are set by a mechanical mechanism so as not to be moved in a reset state, and driving of the chronograph hands is performed after the setting by the mechanical mechanism is cancelled.

What is claimed is:

1. A chronograph timepiece comprising:
chronograph hands that display measured time when chronograph measurement is performed;
a motor that rotatably drives the chronograph hands;
operation means that performs start, stop, and reset operations of the chronograph measurement;
control means that drives the motor by starting a chronograph measurement operation in response to the start operation using the operation means and stops driving of the motor by stopping the chronograph measurement operation in response to the stop operation;
reset means that mechanically resets the chronograph hands to zero in response to the reset operation using the operation means so as to be maintained and electrically resets the chronograph measurement operation;
a secondary cell as a power source; and
mode changing means that changes operation modes of the control means such that a transition to a sleep mode occurs in which the chronograph measurement operation is forbidden when a voltage from the secondary cell is reduced to a predetermined voltage or less and the sleep mode is cancelled so as to start the chronograph measurement operation when the voltage from the secondary cell exceeds the predetermined voltage,
wherein the mode changing means controls the control means in order not to start the chronograph measurement operation even when the start operation is performed using the operation means after the sleep mode is cancelled.

2. A chronograph timepiece according to claim 1, further comprising power generation means that charges the secondary cell,
wherein the mode changing means does not cancel the sleep mode when the voltage from the secondary cell exceeds a predetermined voltage but cancels the sleep mode when an amount of power generated by the power generation means exceeds a predetermined amount.

3. A chronograph timepiece according to claim 1, wherein the mode changing means controls the control means in order to start the chronograph measurement operation in a case where the start operation is performed after the sleep mode is cancelled and the reset operation is performed using the operation means.

4. A chronograph timepiece according to claim 2, wherein the mode changing means controls the control means in order to start the chronograph measurement operation in a case where the start operation is performed after the sleep mode is cancelled and the reset operation is performed using the operation means.

5. A chronograph timepiece according to claim 3, wherein the mode changing means does not control the control means in order to start the chronograph measurement operation in a case where a voltage from the secondary cell is equal to or less than a chronograph measurement enabling a voltage higher than the predetermined voltage by a constant voltage, even when the start operation is performed after the sleep mode is cancelled and the reset operation is performed using the operation means.

6. A chronograph timepiece according to claim 4, wherein the mode changing means does not control the control means in order to start the chronograph measurement operation in a case where a voltage from the secondary cell is equal to or less than a chronograph measurement enabling a voltage higher than the predetermined voltage by a constant voltage, even when the start operation is performed after the sleep mode is cancelled and the reset operation is performed using the operation means.

7. A chronograph timepiece according to claim 1, further comprising:
a time counter means that measures time; and
chronograph counter means that measures chronograph measurement time,
wherein the reset means mechanically resets the chronograph hands to zero in response to the reset operation using the operation means so as to be maintained and resets the time counter means and the chronograph counter means.

8. A chronograph timepiece according to claim 2, further comprising:
a time counter means that measures time; and
chronograph counter means that measures chronograph measurement time,
wherein the reset means mechanically resets the chronograph hands to zero in response to the reset operation using the operation means so as to be maintained and resets the time counter means and the chronograph counter means.

9. A chronograph timepiece according to claim 3, further comprising:
a time counter means that measures time; and
chronograph counter means that measures chronograph measurement time,
wherein the reset means mechanically resets the chronograph hands to zero in response to the reset operation using the operation means so as to be maintained and resets the time counter means and the chronograph counter means.

10. A chronograph timepiece according to claim 4, further comprising:
a time counter means that measures time; and
chronograph counter means that measures chronograph measurement time,
wherein the reset means mechanically resets the chronograph hands to zero in response to the reset operation using the operation means so as to be maintained and resets the time counter means and the chronograph counter means.

11. A chronograph timepiece according to claim 5, further comprising:
a time counter means that measures time; and
chronograph counter means that measures chronograph measurement time,
wherein the reset means mechanically resets the chronograph hands to zero in response to the reset operation using the operation means so as to be maintained and resets the time counter means and the chronograph counter means.

12. A chronograph timepiece according to claim 6, further comprising:
a time counter means that measures time; and
chronograph counter means that measures chronograph measurement time,
wherein the reset means mechanically resets the chronograph hands to zero in response to the reset operation using the operation means so as to be maintained and resets the time counter means and the chronograph counter means.

13. A chronograph timepiece according to claim 1, wherein the reset means mechanically resets the chronograph hands to zero in response to the reset operation using the operation means so as to be maintained and performs a system reset.

14. A chronograph timepiece according to claim 2, wherein the reset means mechanically resets the chronograph hands to zero in response to the reset operation using the operation means so as to be maintained and performs a system reset.

15. A chronograph timepiece according to claim 3, wherein the reset means mechanically resets the chronograph hands to zero in response to the reset operation using the operation means so as to be maintained and performs a system reset.

16. A chronograph timepiece according to claim 4, wherein the reset means mechanically resets the chronograph hands to zero in response to the reset operation using the operation means so as to be maintained and performs a system reset.

17. A chronograph timepiece according to claim 5, wherein the reset means mechanically resets the chronograph hands to zero in response to the reset operation using the operation means so as to be maintained and performs a system reset.

18. A chronograph timepiece according to claim 6, wherein the reset means mechanically resets the chronograph hands to zero in response to the reset operation using the operation means so as to be maintained and performs a system reset.

19. A chronograph timepiece according to claim 7, wherein the reset means mechanically resets the chronograph hands to zero in response to the reset operation using the operation means so as to be maintained and performs a system reset.

20. A chronograph timepiece according to claim 8, wherein the reset means mechanically resets the chronograph hands to zero in response to the reset operation using the operation means so as to be maintained and performs a system reset.
